(19) United States
(12) Patent Application Publication
(10) Pub. No.: US 2023/0204770 A1
(43) Pub. Date: Jun. 29, 2023

(54) RANGING DEVICE AND RANGING SYSTEM

(71) Applicant: SONY SEMICONDUCTOR SOLUTIONS CORPORATION, KANAGAWA (JP)

(72) Inventor: YASUNORI TSUKUDA, TOKYO (JP)

(21) Appl. No.: 18/001,051

(22) PCT Filed: Jun. 3, 2021
(86) PCT No.: PCT/JP2021/021170

§ 371 Date: Dec. 7, 2022

(30) Foreign Application Priority Data
Jun. 16, 2020 (JP) 2020-103551

(51) Int. Cl. G01S 17/10; G01S 7/4863; G01S 7/4865

(52) U.S. Cl. CPC G01S 17/10; G01S 7/4863; G01S 7/4865

(57) ABSTRACT

A ranging device according to the present disclosure includes an avalanche photodiode (APD) (10), a first histogram generating section (24), an element operating section (26), a second histogram generating section (31), and a calculating section (25). The first histogram generating section (24) generates a first histogram that is a histogram of time from a timing at which a light source emits light to a timing at which the APD (10) receives the light. The element operating section (26) enables operation of the APD (10) on the basis of an enable signal (S1). The second histogram generating section (31) generates a second histogram that is a histogram of time from a timing at which the enable signal (S1) is switched to a timing at which the APD (10) is brought into a valid state. The calculating section (25) calculates a distance (D) to an object to be measured (X) on the basis of at least one of the first histogram or the second histogram.

### FIELD

The present disclosure relates to a ranging device and a ranging system.

### BACKGROUND

As one of ranging methods of measuring a distance to an object to be measured by using light, a ranging method called a direct time of flight (ToF) method is known. In ranging processing by the direct ToF method, time from an emission timing indicating emission of light by a light source to a light reception timing at which reflected light that is the light reflected by the object to be measured is received by a light receiving element is measured, and a distance to the object to be measured is calculated on the basis of the measured time.

### CITATION LIST

### Patent Literature

Patent Literature 1: Japanese Patent Application Laid-open No. 2015-117970

### SUMMARY

### Technical Problem

However, in the above-described conventional technology, there is room for further improvement in terms of expansion of a distance measuring range.

Thus, the present disclosure proposes a ranging device and a ranging system capable of expanding a distance measuring range in the direct ToF method.

### Solution to Problem

According to the present disclosure, there is provided a ranging device. The ranging device includes an avalanche photodiode (APD), a first histogram generating section, an element operating section, a second histogram generating section, and a calculating section. The first histogram generating section generates a first histogram that is a histogram of time from a timing at which a light source emits light to a timing at which the APD receives the light. The element operating section enables operation of the APD on the basis of an enable signal. The second histogram generating section generates a second histogram that is a histogram of time from a timing at which the enable signal is switched to a timing at which the APD is brought into a valid state. The calculating section calculates a distance to an object to be measured on the basis of at least one of the first histogram or the second histogram.

### BRIEF DESCRIPTION OF DRAWINGS

FIG. 1 is a view schematically depicting ranging by a direct ToF method applicable to an embodiment of the present disclosure.

FIG. 2 is a view depicting an example of a first histogram in a ranging system according to the embodiment of the present disclosure.

FIG. 3 is a block diagram depicting an example of a configuration of the ranging system according to the embodiment of the present disclosure.

FIG. 4 is a schematic diagram depicting an example of a configuration of a device applicable to a light receiving section of the ranging system according to the embodiment of the present disclosure.

FIG. 5 is a block diagram depicting a configuration of the light receiving section according to the embodiment of the present disclosure.

FIG. 6 is a description view depicting operation of the ranging system according to the embodiment of the present disclosure in a timing chart.

FIG. 7 is a view for describing operation of a second histogram generating section according to the embodiment of the present disclosure.

FIG. 8 is a description view depicting operation of the ranging system according to the embodiment of the present disclosure in a timing chart.

FIG. 9 is a view for describing the operation of the second histogram generating section according to the embodiment of the present disclosure.

FIG. 10 is a flowchart depicting a procedure of processing executed by a calculating section according to the embodiment of the present disclosure.

FIG. 11 is a view for describing an example of a circuit configuration of a signal delay section according to the embodiment of the present disclosure.

FIG. 12 is a view for describing another example of a circuit configuration of the signal delay section according to the embodiment of the present disclosure.

FIG. 13 is a view for describing another example of a circuit configuration of the signal delay section according to the embodiment of the present disclosure.

FIG. 14 is a block diagram depicting a configuration of a light receiving section according to a first modification example of the embodiment of the present disclosure.

FIG. 15 is a block diagram depicting a configuration of a light receiving section according to a second modification example of the embodiment of the present disclosure.

FIG. 16 is a block diagram depicting a configuration of a light receiving section according to a third modification example of the embodiment of the present disclosure.

FIG. 17 is a block diagram depicting a configuration of a light receiving chip according to a fourth modification example of the embodiment of the present disclosure.

FIG. 18 is a block diagram depicting a configuration of a light receiving section according to a fifth modification example of the embodiment of the present disclosure.

FIG. 19 is a description view depicting operation of a ranging system according to the fifth modification example of the embodiment of the present disclosure in a timing chart.

FIG. 20 is a description view depicting operation of the ranging system according to the fifth modification example of the embodiment of the present disclosure in a timing chart.

FIG. 21 is a block diagram depicting an example of schematic configuration of a vehicle control system as an example of a mobile body control system to which the technology according to an embodiment of the present disclosure can be applied.

FIG. 22 is a view depicting an example of an installation position of an imaging section.

### DESCRIPTION OF EMBODIMENTS

In the following, each of embodiments of the present disclosure will be described in detail on the basis of the drawings. Note that in each of the following embodiments, overlapped description is omitted by assignment of the same reference sign to the same parts.

As one of ranging methods of measuring a distance to an object to be measured by using light, a ranging method called a direct time of flight (ToF) method is known. In ranging processing by the direct ToF method, time from an emission timing indicating emission of light by a light source to a light reception timing at which reflected light that is the light reflected by the object to be measured is received by a light receiving element is measured, and a distance to the object to be measured is calculated on the basis of the measured time.

However, in the above-described conventional technology, there is room for further improvement in terms of expansion of a distance measuring range. For example, in the above-described conventional technology, in a case where a photon is incident on an avalanche photodiode (APD) while the APD is performing recharge operation, it is difficult to detect the incidence of this photon. Thus, it is difficult to measure an object to be measured at a short distance.

Thus, it is expected to realize a technology capable of overcoming the above-described problems and expanding a distance measuring range.

[Ranging Method]

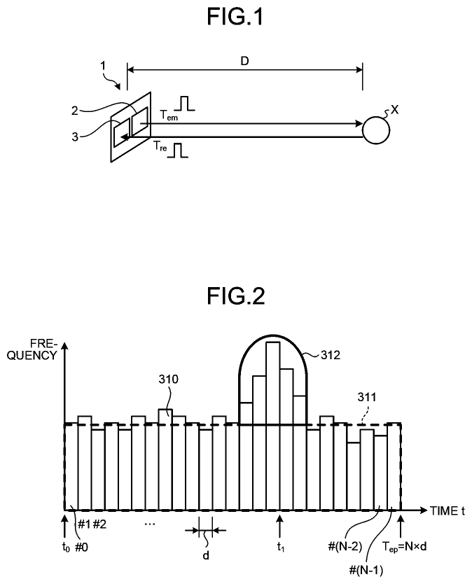

The present disclosure relates to a technology of performing ranging by using light. Thus, in order to facilitate understanding of an embodiment of the present disclosure, a ranging method applicable to the embodiment will be described with reference to FIG. 1 and FIG. 2.

FIG. 1 is a view schematically depicting ranging by a direct ToF method applicable to the embodiment of the present disclosure. In the embodiment, the direct ToF method is applied as the ranging method.

The direct ToF method is a method in which a light receiving section 3 receives reflected light, which is light emitted from a light source section 2 and reflected by an object to be measured X, and ranging is performed on the basis of a time difference between a light emission timing and a light reception timing.

As depicted in FIG. 1, a ranging system 1 according to the embodiment includes the light source section 2 and the light receiving section 3. The light source section 2 is an example of a light source, and the light receiving section 3 is an example of a ranging device. The light source section 2 is, for example, a laser diode, and is driven to emit laser light in a pulsed manner.

The light emitted from the light source section 2 is reflected by the object to be measured X and received by the light receiving section 3 as reflected light. The light receiving section 3 includes a light receiving element that converts light into an electric signal by photoelectric conversion, and outputs a signal corresponding to the received light.

Here, it is assumed that time at which the light source section 2 emits light (light emission timing) is time Tₑₘ, and time at which the light receiving section 3 receives reflected light, which is the light emitted from the light source section 2 and reflected by the object to be measured X (light reception timing) is time Tᵣₑ.

When it is assumed that a constant c is a light velocity (2.9979×10⁸ [m/sec]), a distance D between the ranging system 1 and the object to be measured X is calculated by the following equation (1).

D=(c/2)×(Tₑₘ−Tᵣₑ) (1)

The ranging system 1 repeatedly executes the above-described processing a plurality of times. The light receiving section 3 may include a plurality of light receiving elements, and the distance D may be calculated on the basis of each light reception timing at which the reflected light is received by each light receiving element.

The ranging system 1 according to the embodiment classifies time Tm from the light emission timing of the light source section 2 to the light reception timing of the light receiving section 3 (referred to as light reception time Tm) on the basis of time bins (bins: class) and generates a first histogram.

Note that the light received by the light receiving section 3 during the light reception time Tm is not limited to the reflected light that is the light emitted by the light source section 2 and reflected by the object to be measured X. For example, ambient light around the ranging system 1 (light receiving section 3) is also received by the light receiving section 3.

FIG. 2 is a view depicting an example of the first histogram in the ranging system 1 according to the embodiment of the present disclosure. In FIG. 2, a horizontal axis represents time bins, and a vertical axis represents a frequency in each time bin. The time bins are the light reception time Tm classified in predetermined units of time d.

Specifically, a time bin #0 is 0≤Tm<d, a time bin #1 is d Tm≤2×d, a time bin #2 is 2×d≤Tm<3×d, . . . , and a time bin #(N−2) is (N−2)×d≤Tm<(N−1)×d. In a case where an exposure time of the light receiving section 3 is time Tₑₚ, Tₑₚ=N×d.

The ranging system 1 (see FIG. 1) counts the number of times of obtaining of the light reception time Tm on the basis of the time bins, calculates a frequency 310 for each of the time bins, and generates the first histogram. Here, the light receiving section 3 (see FIG. 1) also receives light other than the reflected light that is the light emitted from the light source section 2 (see FIG. 1) and reflected.

Examples of such light other than the target reflected light include the above-described ambient light. A portion indicated by a range 311 in the first histogram includes an ambient light component due to the ambient light. The ambient light is light that randomly becomes incident on the light receiving section 3, and becomes noise for the target reflected light.

On the other hand, the target reflected light is light received according to a specific distance, and appears as an active light component 312 in the first histogram. A time bin corresponding to a frequency of a peak in this active light component 312 is a time bin corresponding to the distance D of the object to be measured X (see FIG. 1).

By obtaining representative time of the time bin (such as time in a middle of the time bin) as the above-described time Tre, the ranging system 1 according to the embodiment can calculate the distance D to the object to be measured X according to the above-described equation (1). In such a manner, by using a plurality of light reception results, appropriate ranging can be executed with respect to random noise.

[Configuration of a Ranging System]

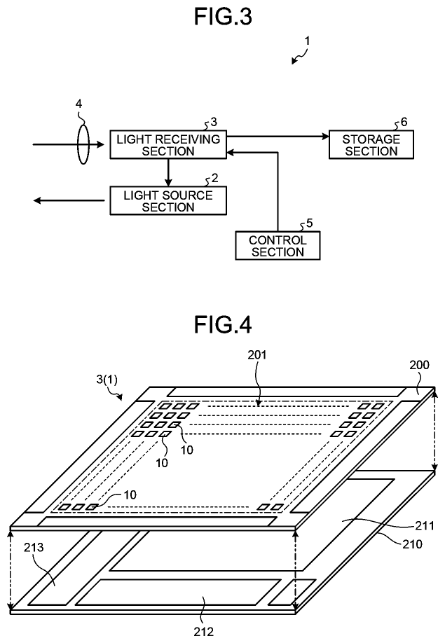

Next, a configuration of the ranging system 1 according to the embodiment will be described with reference to FIG. 3. FIG. 3 is a block diagram depicting an example of the configuration of the ranging system 1 according to the embodiment of the present disclosure. As depicted in FIG. 3, the ranging system 1 according to the embodiment includes the light source section 2, the light receiving section 3, an optical system 4, a control section 5, and a storage section 6.

The light source section 2 is, for example, a laser diode, and is driven to emit laser light in a pulsed manner. As the light source section 2, a vertical cavity surface emitting laser (VCSEL) that emits laser light as a surface light source can be applied.

Note that, in the embodiment, the light source section 2 is not limited to the VCSEL, and a configuration of using an array in which laser diodes are arrayed on a line and performing scanning with laser light emitted from the laser diode array in a direction perpendicular to the line may be applied as the light source section 2.

Furthermore, it is also possible to apply a configuration in which the light source section 2 includes a laser diode as a single light source and scanning with laser light emitted from the laser diode is performed in horizontal and vertical directions.

The light receiving section 3 includes one or a plurality of light receiving elements. The light receiving element according to the embodiment is, for example, an APD. Note that the light receiving element according to the embodiment is not limited to the APD, and may be, for example, a single photon avalanche diode (SPAD) or the like.

In a case where the light receiving section 3 includes a plurality of light receiving elements, the plurality of light receiving elements is arrayed in, for example, a two-dimensional lattice shape and forms a light receiving surface. The optical system 4 guides light incident from the outside to the light receiving surface.

The control section 5 controls the entire operation of the ranging system 1. For example, the control section 5 supplies, to the light receiving section 3, a light emission trigger that is a trigger for causing the light source section 2 to emit light. The light receiving section 3 causes the light source section 2 to emit light at a timing based on this light emission trigger, and stores the time Tem indicating the light emission timing. Furthermore, the control section 5 sets a pattern at the time of ranging with respect to the light receiving section 3, for example, in response to an instruction from the outside.

The light receiving section 3 repeatedly obtains time information indicating the timing at which light is received on the light receiving surface (light reception time Tm) within a predetermined time range, calculates a frequency for each time bin, and generates the above-described first histogram. The ranging system 1 further calculates the distance D to the object to be measured X on the basis of the generated first histogram. Information indicating the calculated distance D is stored in the storage section 6.

[Configuration of a Device]

Next, a configuration of a device applicable to the light receiving section 3 of the ranging system 1 according to the embodiment will be described with reference to FIG. 4. FIG. 4 is a schematic diagram depicting an example of the configuration of the device applicable to the light receiving section 3 of the ranging system 1 according to the embodiment.

As depicted in FIG. 4, a light receiving chip 200 and a logic chip 210 each of which is formed of a semiconductor chip are stacked, whereby the light receiving section 3 of the ranging system 1 is configured. Note that the light receiving chip 200 and the logic chip 210 are depicted in a separated state in FIG. 4 for the sake of the description.

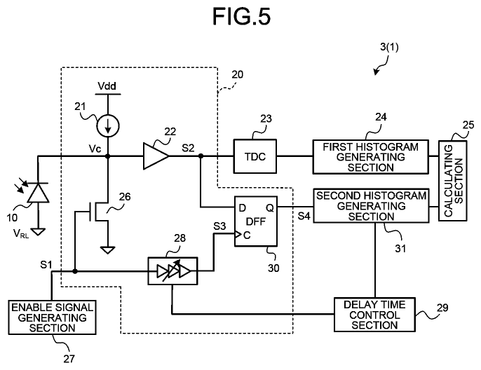

In the light receiving chip 200, a plurality of the APDs 10 is arrayed in a two-dimensional lattice shape in a region of a pixel array section 201. Furthermore, various elements such as unit circuits 20 (see FIG. 5) respectively connected to the APDs 10 are formed in the logic chip 210.

The APDs 10 formed in the light receiving chip 200 and the unit circuits 20 formed in the logic chip 210 are connected via coupling sections (not illustrated) such as copper-copper connection (CCC).

A logic array section 211 that processes signals obtained by the APDs 10 is provided in the logic chip 210. The plurality of unit circuits 20 respectively connected to the APDs 10 is provided in the logic array section 211. For example, the plurality of unit circuits 20 is arrayed in a two-dimensional lattice shape at positions corresponding to the plurality of APDs 10 in the logic array section 211.

Furthermore, a signal processing section 212 and a device control section 213 are provided in proximity to the logic array section 211 in the logic chip 210. The signal processing section 212 includes a TDC 23, a first histogram generating section 24, a calculating section 25, a delay time control section 29, a second histogram generating section 31, and the like depicted in FIG. 5 (described later).

The device control section 213 controls the operation as the light receiving section 3. The device control section 213 can include a clock generating section that generates a reference clock, a light emission control section that controls light emission of the light source section 2, an interface that transmits and receives various signals to and from the outside, and the like.

Note that the configurations on the light receiving chip 200 and the logic chip 210 are not limited to the above-described example. For example, in addition to the arrangement depicted in FIG. 4, a functional section having an arbitrary function can be provided in an arbitrary region of the light receiving chip 200 and the logic chip 210.

[Configuration of a Light Receiving Section and Operation of a Ranging System]

Next, the configuration of the light receiving section 3 and the operation of the ranging system 1 according to the embodiment will be described with reference to FIG. 5 to FIG. 13. FIG. 5 is a block diagram depicting the configuration of the light receiving section 3 according to the embodiment of the present disclosure.

As depicted in FIG. 5, the light receiving section 3 according to the embodiment includes the APDs 10, a charging section 21, an output section 22, a time-to-digital conversion circuit (hereinafter, also referred to as TDC) 23, the first histogram generating section 24, and the calculating section 25. Furthermore, the light receiving section 3 according to the embodiment includes an element operating section 26, an enable signal generating section 27, a signal delay section 28, the delay time control section 29, an APD state detecting section 30, and the second histogram generating section 31.

In the embodiment, as depicted in FIG. 5, each of the unit circuits 20 includes the charging section 21, the output section 22, the element operating section 26, the signal delay section 28, and the APD state detecting section 30 among the sections in the light receiving section 3.

The APDs 10 are an example of the light receiving element. A cathode of each of the APDs 10 is connected to an output terminal of the charging section 21 that is a constant current source, and an anode of the APD 10 is connected to a voltage source of a negative voltage (VRL) corresponding to a breakdown voltage of the APD 10.

The charging section 21 is, for example, a constant current source, and supplies a current of a predetermined constant value to the APD 10. Then, the APD 10 is recharged (charged) by the current supplied from the charging section 21. An input terminal of the charging section 21 is connected to a power supply voltage Vdd.

Note that, in the light receiving section 3 according to the embodiment, the charging section 21 is not limited to a case of including the constant current source and may include a transistor or the like in which a predetermined constant voltage is applied to a resistance element or a gate.

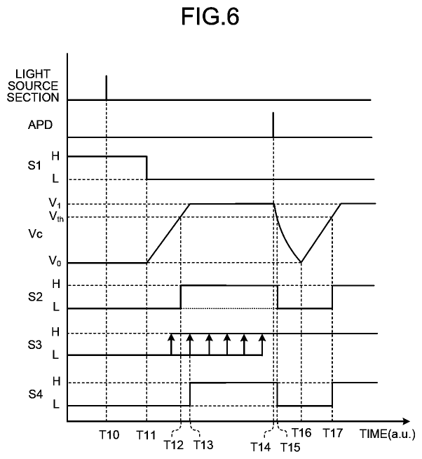

An input terminal of the output section 22 is connected to the cathode of the APD 10, and an output terminal of the output section 22 is connected to an input terminal of the TDC 23. The output section 22 includes, for example, an operational amplifier. In a case where an input cathode voltage Vc becomes equal to or higher than a predetermined threshold voltage Vth (see FIG. 6), the output section 22 outputs a high-level state signal S2 from the output terminal.

On the other hand, in a case where the input cathode voltage Vc is lower than the threshold voltage Vth, the output section 22 outputs a low-level state signal S2 from the output terminal. That is, the state signal S2 output from the output section 22 indicates a voltage state of the APD 10 (in the embodiment, voltage state of the cathode voltage Vc of the APD 10).

The TDC 23 measures time on the basis of the state signal S2 from the output section 22, and converts the measured time into time information in a digital value. The TDC 23 includes, for example, a counter that counts time from the light emission timing at which the light source section 2 (see FIG. 3) emits light to the light reception timing at which the APD 10 receives the light.

Such a counter starts measurement (counting) of time in synchronization with a light emission control signal supplied from the light emission control section included in the device control section 213 (see FIG. 4). The counter ends the measurement of time in accordance with an inversion timing of the state signal S2 supplied from the output section 22.

The TDC 23 outputs, to the first histogram generating section 24, time information obtained by conversion of the number of counts from the start to the end of the measurement of time by a counter into a digital value.

The first histogram generating section 24 classifies the time information output from the TDC 23 according to the histogram, and increments a value of a corresponding time bin of the histogram. As a result, the first histogram generating section 24 generates the first histogram depicted in FIG. 2.

The calculating section 25 calculates the distance D (see FIG. 1) to the object to be measured X (see FIG. 1) on the basis of at least one of the first histogram generated by the first histogram generating section 24 or a second histogram generated by the second histogram generating section 31. Details of the operation of the calculating section 25 will be described later.

The element operating section 26 enables the operation of the APD 10 on the basis of an enable signal S1 supplied from the enable signal generating section 27. The element operating section 26 includes, for example, an N-type transistor, a drain of the N-type transistor is connected to the cathode of the APD 10, and a source of the N-type transistor is grounded. Furthermore, the enable signal S1 is supplied to a gate of the element operating section 26 that is the N-type transistor.

Then, in a case where the high-level enable signal S1 is supplied to the element operating section 26, a constant current from the charging section 21 flows to the element operating section 26 instead of the APD 10 since the element operating section 26 is in a conductive state. As a result, since the APD 10 is not charged, the APD 10 is brought into an invalid state.

On the other hand, in a case where the low-level enable signal S1 is supplied to the element operating section 26, the constant current from the charging section 21 is supplied to the APD 10 since the element operating section 26 is in a disconnected state. As a result, since the APD 10 is charged, the APD 10 is brought into a valid state.

As described above, in the embodiment, the APD 10 can be switched between the valid state and the invalid state by switching of levels of the enable signal S1.

The enable signal generating section 27 generates a switched enable signal S1 at a timing based on the light emission timing of the light source section 2, or the like.

The signal delay section 28 delays the enable signal S1 supplied from the enable signal generating section 27 for a predetermined time, and outputs the delayed enable signal (hereinafter, also referred to as delay enable signal S3).

Specifically, the signal delay section 28 delays the enable signal S1 on the basis of a delay time set by the delay time control section 29, and outputs the delay enable signal S3 to the APD state detecting section 30.

The delay time control section 29 sets the delay time of the enable signal S1. For example, the delay time control section 29 sets a plurality of delay times in such a manner that sweeping is performed within a predetermined time range, and transmits the plurality of delay times to the signal delay section 28 as needed.

The APD state detecting section 30 detects a state of the APD 10. Specifically, in a case where the delay enable signal S3 transitions from a low level to a high level, the APD state detecting section 30 detects whether the APD 10 is in the valid state or the invalid state.

The APD state detecting section 30 includes, for example, a D-type flip-flop (DFF). Then, the state signal S2 is supplied to a D terminal of the D-type flip-flop, and the delay enable signal S3 is supplied to a C terminal.

As a result, in a case where the APD 10 is in the valid state in a case where the delay enable signal S3 transitions from the low level to the high level, the APD state detecting section 30 outputs a high-level signal S4 from a Q terminal.

On the other hand, in a case where the delay enable signal S3 does not transition from the low level to the high level or in a case where the APD 10 is in the invalid state, the APD state detecting section 30 outputs a low-level signal S4 from the Q terminal.

The second histogram generating section 31 generates a second histogram on the basis of the signal S4 output from the APD state detecting section 30 and the delay time of the delay enable signal S3 which delay time is set by the delay time control section 29. This second histogram is a histogram of time from a timing at which the enable signal S1 is switched to a timing at which the APD 10 is brought into the valid state. Details of the operation of the second histogram generating section 31 will be described later.

FIG. 6 is a description view depicting operation of the ranging system 1 according to the embodiment of the present disclosure in a timing chart. As depicted in FIG. 6, in the ranging system 1 according to the embodiment, the enable signal S1 is set to the high level and the APD 10 is brought into the invalid state at time T10 that is a timing at which the light source section 2 emits light.

As a result, it is possible to prevent unintended reflected light reflected in a housing of the ranging system 1 or the like from becoming incident on the APD 10 and invalidating the APD 10.

The enable signal generating section 27 switches the enable signal S1 to the low level at time T11 that is after a predetermined time from the time T10 at which the light source section 2 emits the light. As a result, supplying of the constant current from the charging section 21 to the APD 10 (that is, recharging of the APD 10) is started, and the cathode voltage Vc of the APD 10 is linearly boosted from a predetermined voltage V₀.

Then, at time T12 at which the cathode voltage Vc of the APD 10 becomes equal to or higher than the threshold voltage Vₜₕ, the output section 22 outputs the high-level state signal S2. Furthermore, the cathode voltage Vc of the APD 10 is boosted to a predetermined voltage V₁ by the charging section 21.

As described above, the APD 10 in which the cathode voltage Vc is boosted to the voltage V₁ and to which a predetermined reverse bias voltage is applied is in a state immediately before avalanche amplification called a Geiger mode is generated.

Note that, in the embodiment, the charging section 21 may be operated in such a manner as to correspond to operation of the element operating section 26, and control may be performed in such a manner that the charging section 21 does not operate when the APD 10 is in the invalid state. As a result, it is not necessary to constantly operate the charging section 21, and power consumption of the ranging system 1 can be reduced.

In parallel with the charging processing of the APD 10 described above, the signal delay section 28 outputs the delay enable signal S3 in which a rise is delayed for a predetermined time from the time T11 at which the enable signal S1 is switched to the low level.

Here, as depicted in FIG. 6, the signal delay section 28 outputs a plurality of the delay enable signals S3 having different switching timings on the basis of the plurality of delay times set in such a manner that sweeping is performed within the predetermined time range.

Then, the APD state detecting section 30 outputs the high-level signal S4 at time T13 which is after the time T12, the state signal S2 being switched to the high level at the time T12, and at which a delay enable signal S3 having a switching timing closest to the time T12 is switched to the high level.

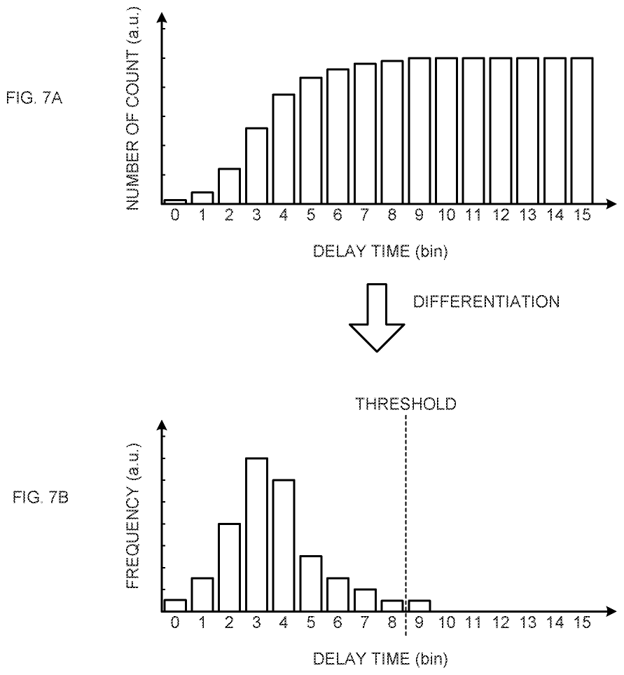

FIG. 7 is a view for describing operation of the second histogram generating section 31 according to the embodiment of the present disclosure. In a case where the signal S4 is at the high level in each delay time, the second histogram generating section 31 increments a value of a time bin corresponding to the delay time.

As a result, the second histogram generating section 31 generates a histogram in a manner depicted in (a) of FIG. 7. The histogram in (a) of FIG. 7 is a histogram generated on the basis of a raw count value of the signal S4.

Then, the second histogram generating section 31 generates a second histogram in a manner depicted in (b) of FIG. 7 by differentiation of the generated histogram of the raw count value. In the second histogram, time from the timing at which the enable signal S1 is switched in such a manner that the APD 10 operates effectively (corresponding to time T11) to the timing at which the APD 10 is brought into the valid state (corresponding to time T13) on the basis of the time bins.

Thus, in the embodiment, a time bin corresponding to a frequency of a peak in the second histogram depicted in (b) of FIG. 7 can be regarded as the time bin corresponding to the time from the timing at which the enable signal S1 is switched to the timing at which the APD 10 is brought into the valid state.

That is, in the embodiment, the time from the timing at which the enable signal S1 is switched to the timing at which the APD 10 is brought into the valid state can be measured by the signal delay section 28, the delay time control section 29, the APD state detecting section 30, and the second histogram generating section 31.

Then, in the example of (b) of FIG. 7, since a time bin corresponding to a frequency of a peak is smaller than a predetermined threshold, it can be considered that no photon is incident on the APD 10 (APD 10 is quickly charged) until the cathode voltage Vc reaches the threshold voltage Vₜₕ.

The description returns to FIG. 6. When a photon caused by the reflected light from the object to be measured X becomes incident on the APD 10 at time T14 after the APD 10 becomes the Geiger mode, avalanche multiplication is generated inside the APD 10 due to an electron generated in response to the incidence of the photon. As a result, current flows through the APD 10, a voltage drop is generated, and the cathode voltage Vc decreases nonlinearly.

That is, the APD 10 has a characteristic that a large current flows in response to an incidence of one photon. Then, the APD 10 can detect the incidence of one photon included in the reflected light with high sensitivity by using such a characteristic.

Then, when the cathode voltage Vc becomes lower than the threshold voltage Vₜₕ at time T15, the output section 22 outputs the low-level state signal S2.

Then, since the avalanche amplification in the APD 10 stops at time T16, the cathode voltage Vc of the APD 10 stops decreasing at the voltage V₀. Furthermore, the cathode voltage Vc of the APD 10 increases as the APD 10 is recharged by the charging section 21.

Then, at time T17 at which the cathode voltage Vc of the APD 10 becomes equal to or higher than the threshold voltage Vₜₕ, the output section 22 outputs the high-level state signal S2. Furthermore, the cathode voltage Vc of the APD 10 is boosted to the predetermined voltage V₁, and the APD 10 returns to the Geiger mode.

Here, in the embodiment, the TDC 23 measures the time from the light emission timing at which the light source section 2 emits light (corresponding to time T10) to the light reception timing at which the APD 10 receives the light (corresponding to time T14).

Note that the time T15 at which the state signal S2 is switched to the low level is regarded as the timing at which the APD 10 receives the light in the embodiment. In the APD 10, since the voltage drop is generated in a very short time after one photon becomes incident, there is no practical problem even when the time T15 is regarded as the timing at which the APD 10 receives the light.

The first histogram generating section 24 generates the first histogram depicted in FIG. 2 on the basis of the time from the light emission timing to the light reception timing which time is measured by the TDC 23. Then, in a case where a peak is detected in the first histogram, the calculating section 25 calculates the distance D to the object to be measured X on the basis of the above-described equation (1).

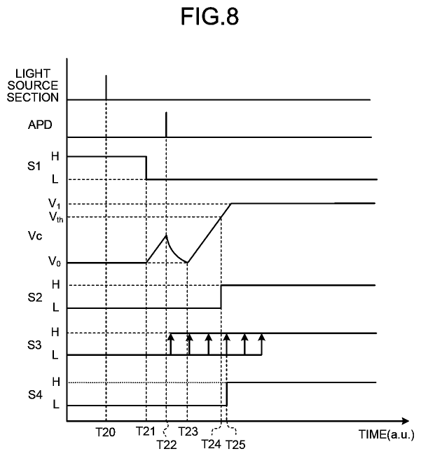

FIG. 8 is a description view illustrating the operation of the ranging system 1 according to the embodiment of the present disclosure in a timing chart, and illustrating a case where the object to be measured X is at a close position compared to the example of FIG. 6 described above.

As depicted in FIG. 8, similarly to the example of FIG. 6, in the ranging system 1 according to the embodiment, the enable signal S1 is set to the high level and the APD 10 is brought into the invalid state at time T20 that is a timing at which the light source section 2 emits light.

The enable signal generating section 27 switches the enable signal S1 to the low level at time T21 that is after a predetermined time from the time T20 at which the light source section 2 emits the light. As a result, recharging of the APD 10 is started, and the cathode voltage Vc of the APD 10 is linearly boosted from the predetermined voltage V₀.

However, in the example of FIG. 8, since the object to be measured X is at a close position, a photon caused by the reflected light from the object to be measured X becomes incident on the APD 10 at time T22 before the cathode voltage Vc of the APD 10 becomes equal to or higher than the threshold voltage Vₜₕ.

Then, avalanche multiplication is generated inside the APD 10 due to an electron generated in response to the incidence of the photon, current flows through the APD 10, and a voltage drop is generated, whereby the cathode voltage Vc decreases nonlinearly.

Then, since the avalanche amplification in the APD 10 stops at time T23, the cathode voltage Vc of the APD 10 stops decreasing at the voltage V₀. Furthermore, the cathode voltage Vc of the APD 10 increases as the APD 10 is recharged by the charging section 21.

Then, at time T24 at which the cathode voltage Vc of the APD 10 becomes equal to or higher than the threshold voltage Vₜₕ, the output section 22 outputs the high-level state signal S2. Furthermore, the cathode voltage Vc of the APD 10 is boosted to the predetermined voltage V₁, and the APD 10 is brought into the Geiger mode.

In parallel with the charging processing of the APD 10 described above, the signal delay section 28 outputs the delay enable signal S3 in which a rise is delayed for a predetermined time from the time T21 at which the enable signal S1 is switched to the low level.

Similarly to the example of FIG. 6, the signal delay section 28 outputs a plurality of the delay enable signals S3 having different switching timings on the basis of the plurality of delay times set in such a manner that sweeping is performed within the predetermined time range.

Then, the APD state detecting section 30 outputs the high-level signal S4 at time T25 which is after the time T24, the state signal S2 being switched to the high level at the time T24, and at which a delay enable signal S3 having a switching timing closest to the time T24 is switched to the high level.

In the example of FIG. 8 described above, since the TDC 23 cannot detect the light reception timing at which the light is received by the APD 10, a peak caused by the reflected light from the object to be measured X is not detected in the first histogram. Thus, in the example of FIG. 8, the calculating section 25 cannot calculate the distance D to the object to be measured X by using the first histogram.

On the other hand, in the example of FIG. 8, the time until the APD 10 is brought into the valid state is longer than that in the example of FIG. 6 due to the reflected light from the object to be measured X at the close position. Thus, in the example of FIG. 8, the distance D to the object to be measured X at the close position is calculated on the basis of time from the timing at which the enable signal S1 is switched to the timing at which the APD 10 is brought into the valid state.

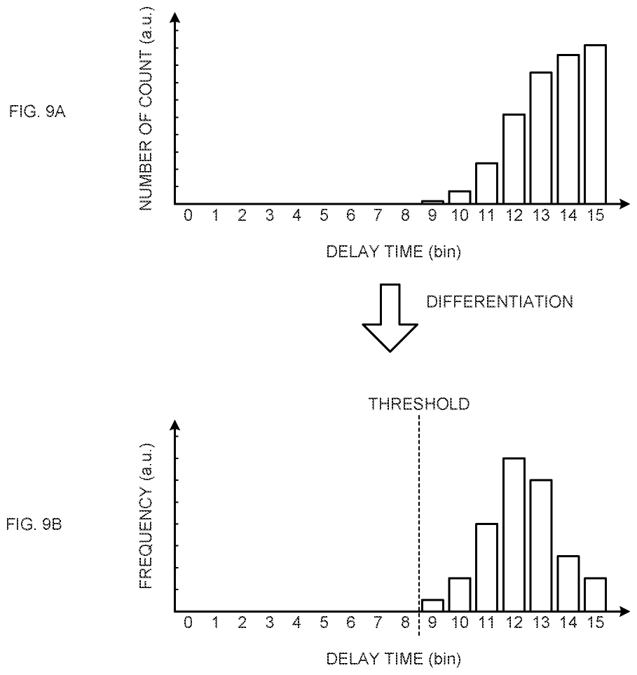

FIG. 9 is a view for describing the operation of the second histogram generating section 31 according to the embodiment of the present disclosure, and illustrating the operation of the second histogram generating section 31 in the example of FIG. 8. In a case where the signal S4 is at the high level in each delay time, the second histogram generating section 31 increments a value of a time bin corresponding to the delay time.

As a result, the second histogram generating section 31 generates a histogram in a manner depicted in (a) of FIG. 9. The histogram in (a) of FIG. 9 is a histogram generated on the basis of a raw count value of the signal S4 in the example of FIG. 8.

Then, the second histogram generating section 31 generates a second histogram in a manner depicted in (b) of FIG. 9 by differentiation of the generated histogram of the raw count value. In the second histogram, the time from the timing at which the enable signal S1 is switched in such a manner that the APD 10 operates effectively (corresponding to time T21) to the timing at which the APD 10 is brought into the valid state (corresponding to time T24) on the basis of the time bins.

Thus, in the embodiment, a time bin corresponding to a frequency of a peak in the second histogram depicted in (b) of FIG. 9 can be regarded as the time bin corresponding to the time from the timing at which the enable signal S1 is switched to the timing at which the APD 10 is brought into the valid state.

That is, in the embodiment, the time from the timing at which the enable signal S1 is switched to the timing at which the APD 10 is brought into the valid state can be measured by the signal delay section 28, the delay time control section 29, the APD state detecting section 30, and the second histogram generating section 31.

Then, in the example of (b) of FIG. 9, since the time bin corresponding to the frequency of the peak is equal to or larger than the predetermined threshold, it can be seen that the APD 10 is not charged quickly. That is, in the example of (b) of FIG. 9, it can be considered that a photon is incident on the APD 10 until the cathode voltage Vc of the APD 10 reaches the threshold voltage Vₜₕ.

Thus, in the example of FIG. 8, the time T22 at which the photon becomes incident on the APD 10 is estimated on the basis of the time T21 at which the enable signal S1 is switched and the time T25 at which the signal S4 becomes the high level.

Note that as depicted in FIG. 8, while the cathode voltage Vc is linearly boosted when the APD 10 is charged, the cathode voltage Vc is nonlinearly stepped down when the photon becomes incident on the APD 10. Thus, in the embodiment, at the time of estimation processing of the time T22, the estimation processing may be performed in such a manner as to correct asymmetry between the time of boosting and the time of stepping down in the cathode voltage Vc.

For example, in the embodiment, a conversion table is stored in advance in the storage section 6 of the ranging system 1 or the like (see FIG. 3), and the conversion table includes a value of the time T22 corresponding to a value of the time T21 and a value of the time T25.

Then, in the embodiment, the value of the time T22 included in the conversion table is set to a value in which the asymmetry between the time of boosting and the time of stepping down in the cathode voltage Vc is corrected. As a result, the value of the time T22 can be accurately estimated, whereby the distance D to the object to be measured X can be accurately calculated.

Note that, in the embodiment, the estimation processing of the time T22 is not limited to a case of being performed by utilization of the conversion table, and may be performed by utilization of, for example, a conversion formula for calculating the value of the time T22 according to the value of the time T21 and the value of the time T25. Furthermore, in this case, a term for correcting the asymmetry between the time of boosting and the time of stepping down in the cathode voltage Vc may be provided inside the conversion formula.

Then, the calculating section 25 calculates the distance D to the object to be measured X by inputting the value of the time T21 and the value of the time T22 estimated in the above to the above-described equation (1). As a result, even in a case where the object to be measured X is at the close position, the distance D to the object to be measured X can be calculated.

As described above, in the embodiment, in addition to the calculation processing of the distance D by the first histogram, the distance D can be calculated by utilization of the second histogram with respect to the object to be measured X at the short distance. Thus, according to the embodiment, the distance measuring range can be expanded in the direct ToF method.

Furthermore, in the embodiment, by calculating the distance D to the object to be measured X by using the time-to-digital conversion circuit (TDC) 23 and the first histogram generating section 24, it is possible to calculate the timing at which the APD 10 receives the reflected light. Thus, according to the embodiment, the distance D to the object to be measured X can be accurately calculated.

In addition, in the embodiment, by using the signal delay section 28, the delay time control section 29, the APD state detecting section 30, and the second histogram generating section 31, it is possible to calculate the timing at which the reflected light from the object to be measured X at the close position is received.

Note that, in the embodiment, the signal delay section 28, the delay time control section 29, and the APD state detecting section 30 may be replaced with a time-to-digital conversion circuit, and the timing at which the state signal S2 is switched and which is depicted in FIG. 8 (corresponding to time T24) may be measured by the time-to-digital conversion circuit.

As a result, since the second histogram generating section 31 can also generate the second histogram, it is possible to calculate the timing at which the reflected light from the object to be measured X at the close position is received.

On the other hand, the signal delay section 28, the delay time control section 29, and the APD state detecting section 30 can simplify a circuit configuration compared to the time-to-digital conversion circuit. Thus, according to the embodiment, it is possible to realize the ranging system 1 at low cost by using the signal delay section 28, the delay time control section 29, and the APD state detecting section 30.

Furthermore, in the embodiment, the signal delay section 28 and the APD state detecting section 30 are incorporated inside the same unit circuit 20 (that is, inside the logic array section 211) as the output section 22 and the like, as depicted in FIG. 5.

As a result, since a transmission path of the state signal S2 from the output section 22 and a transmission path of the delay enable signal S3 from the signal delay section 28 can be shortened, the state signal S2 and the delay enable signal S3 can be accurately supplied to the APD state detecting section 30.

Thus, according to the embodiment, the distance D to the object to be measured X at the close position can be accurately calculated.

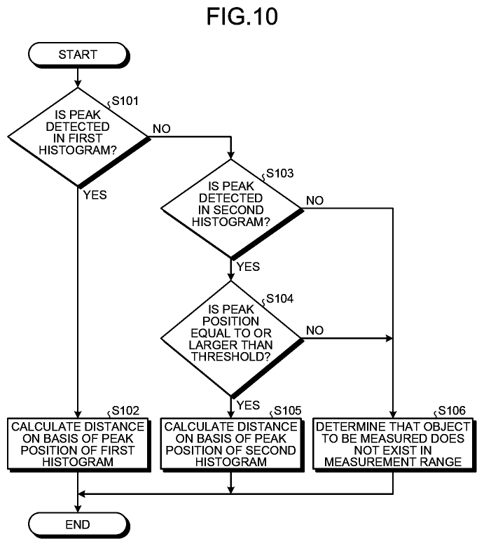

FIG. 10 is a flowchart illustrating a procedure of processing executed by the calculating section 25 according to the embodiment of the present disclosure. First, the calculating section 25 determines whether a peak is detected in the first histogram generated by the first histogram generating section 24 (Step S101).

Then, in a case where a peak is detected in the first histogram (Step S101, Yes), the calculating section 25 calculates the distance D to the object to be measured X on the basis of a peak position of the first histogram (Step S102), and completes the series of processing.

On the other hand, in a case where no peak is detected in the first histogram (Step S101, No), the calculating section 25 determines whether a peak is detected in the second histogram generated by the second histogram generating section 31 (Step S103).

Then, in a case where a peak is detected in the second histogram (Step S103, Yes), the calculating section 25 determines whether a time bin at a peak position of the second histogram is equal to or larger than the predetermined threshold (Step S104).

Then, in a case where the time bin at the peak position of the second histogram is equal to or larger than the predetermined threshold (Step S104, Yes), the calculating section 25 calculates the distance D to the object to be measured X on the basis of the peak position of the second histogram (Step S105), and completes the series of processing.

On the other hand, in a case where the time bin at the peak position of the second histogram is smaller than the predetermined threshold (Step S104, No), the calculating section 25 determines that the object to be measured X does not exist in a measurement range of the ranging system 1 (Step S106), and completes the series of processing.

In addition, in a case where no peak is detected in the second histogram in the processing of Step S103 (Step S103, No), the calculating section 25 proceeds to the processing of Step S106.

Note that the calculating section 25 can determine a time bin having a predetermined number of counts or larger and having the largest number of counts as a peak in the first histogram and the second histogram.

In addition, in the first histogram and the second histogram, the calculating section 25 may differentiate and smooth a count value of each time bin and determine, as the peak, a time bin in which the smoothed value is equal to or larger than the predetermined number of counts and is the largest.

As depicted in FIG. 10, in a case where the peak is detected in the first histogram, the ranging system 1 according to the embodiment performs calculation processing of the distance D by using only the first histogram without using the second histogram.

As a result, since processing related to generation of the second histogram can be omitted, the ranging processing in the ranging system 1 can be easily performed. Thus, according to the embodiment, the power consumption of the ranging system 1 can be reduced.

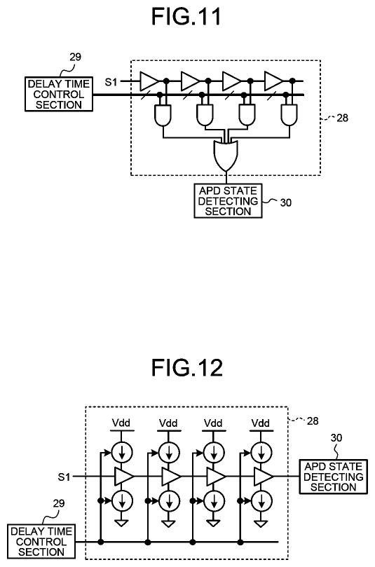

FIG. 11 is a view for describing an example of a circuit configuration of the signal delay section 28 according to the embodiment of the present disclosure. As depicted in FIG. 11, the signal delay section 28 may select a delay amount of the enable signal S1 according to the number of stages of a logic gate.

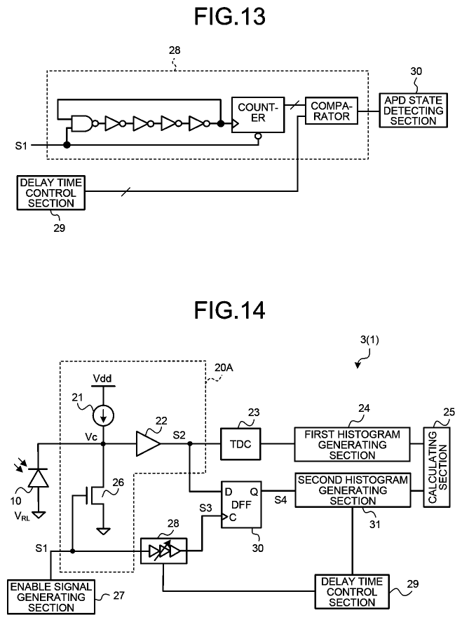

Note that the circuit configuration of the signal delay section 28 is not limited to the example of FIG. 11. FIG. 12 and FIG. 13 are views for describing another example of a circuit configuration of the signal delay section 28 according to the embodiment of the present disclosure.

As depicted in FIG. 12, the signal delay section 28 may select a delay amount of the enable signal S1 by a voltage control delay stage, or may select a delay amount of the enable signal S1 by a gated ring oscillator (GRO) as depicted in FIG. 13.

### First Modification Example

Next, various modification examples of the ranging system 1 according to the embodiment will be described. FIG. 14 is a block diagram depicting a configuration of a light receiving section 3 according to the first modification example of the embodiment of the present disclosure. As depicted in FIG. 14, in the light receiving section 3 according to the first modification example, a configuration of a unit circuit 20A is different from that of the embodiment.

Specifically, the unit circuit 20A of the first modification example includes a charging section 21, an output section 22, and an element operating section 26. That is, in the first modification example, the unit circuit 20A does not include the signal delay section 28 and the APD state detecting section 30.

As a result, since an area of the unit circuit 20A can be reduced, a plurality of the unit circuits 20A can be arranged at high density in a logic array section 211 (see FIG. 4) of a logic chip 210 (see FIG. 4). Thus, according to the first modification example, a chip area of the logic chip 210 can be reduced.

### Second Modification Example

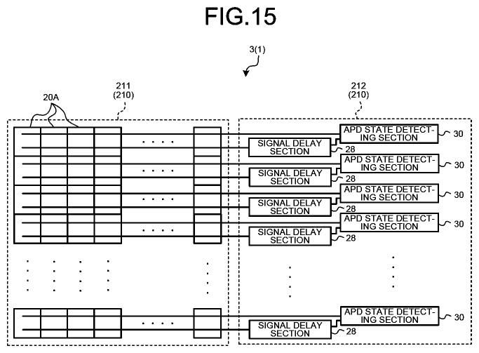

FIG. 15 is a block diagram depicting a configuration of a light receiving section 3 according to the second modification example of the embodiment of the present disclosure. As depicted in FIG. 15, in the light receiving section 3 according to the second modification example, unit circuits 20A depicted in FIG. 14 are two-dimensionally arranged in a matrix in a logic array section 211 of a logic chip 210.

Then, in the second modification example, the plurality of unit circuits 20A arranged in the same row share a set of a signal delay section 28 and an APD state detecting section 30. The set of the signal delay section 28 and the APD state detecting section 30 is arranged in a signal processing section 212 of the logic chip 210.

As a result, the number of the signal delay sections 28 and APD state detecting sections 30 provided in the logic chip 210 can be reduced as compared with a case where the signal delay sections 28 and the APD state detecting sections 30 are individually provided in all the unit circuits 20A.

Thus, according to the second modification example, a ranging system 1 can be realized at low cost since a circuit configuration of the logic chip 210 can be simplified.

Note that the second modification example is not limited to a case where the plurality of unit circuits 20A arranged in the same row shares the set of the signal delay section 28 and the APD state detecting section 30. For example, a plurality of the unit circuits 20A arranged in the same column may share the set of the signal delay section 28 and the APD state detecting section 30, or a plurality of the unit circuits 20A two-dimensionally arrayed in a predetermined range may share the set of the signal delay section 28 and the APD state detecting section 30.

### Third Modification Example

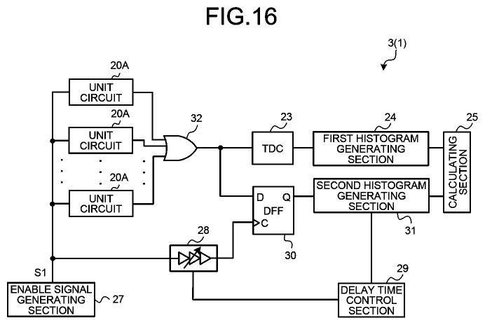

FIG. 16 is a block diagram depicting a configuration of a light receiving section 3 according to the third modification example of the embodiment of the present disclosure. As depicted in FIG. 16, in the light receiving section 3 according to the third modification example, a plurality of unit circuits 20A shares a set of a signal delay section 28 and an APD state detecting section 30 similarly to the second modification example.

Furthermore, in the third modification example, the same enable signal S1 is input to a group of the unit circuits 20A, and an OR circuit 32 is provided between the group of unit circuits 20A and a TDC 23 and the APD state detecting section 30.

With such a circuit configuration, in the third modification example, the group of unit circuits 20A and a group of APDs 10 (see FIG. 14) connected to the group of unit circuits 20 can be operated as one light receiving element. That is, in the light receiving section 3 according to the third modification example, in a case where reflected light becomes incident on any of the APDs 10 in the group of APDs 10 (FIG. 14) connected to the group of unit circuits 20A, a distance D to an object to be measured X can be calculated on the basis of the reflected light.

Thus, according to the third modification example, sensitivity of a ranging system 1 can be improved.

### Fourth Modification Example

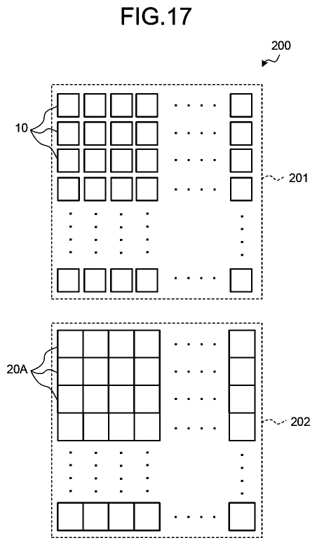

FIG. 17 is a block diagram depicting a configuration of a light receiving chip 200 according to the fourth modification example of the embodiment of the present disclosure. Note that a pixel array section 201 and a logic array section 202 stacked on each other are depicted side by side to facilitate understanding in FIG. 17.

As depicted in FIG. 17, the light receiving chip 200 according to the fourth modification example is configured by stacking of the pixel array section 201 and the logic array section 202. The pixel array section 201 is provided on a light incident side in the light receiving chip 200, and the logic array section 202 is provided on a back side (opposite side of the light incident side) of the pixel array section 201 in the light receiving chip 200.

In such a manner, since both APDs 10 and unit circuits 20A are provided on the light receiving chip 200, transmission paths of a cathode voltage Vc (see FIG. 14) from the APDs 10 to the unit circuits 20A can be shortened.

Thus, according to the fourth modification example, since the cathode voltage Vc can be accurately supplied to the unit circuits 20A, a distance D to an object to be measured X at a close position can be accurately calculated.

Note that a signal processing section 212 (see FIG. 4) and a device control section 213 (see FIG. 4) are provided in the logic chip 210 (see FIG. 4), and no logic array section 211 is provided in the fourth modification example.

### Fifth Modification Example

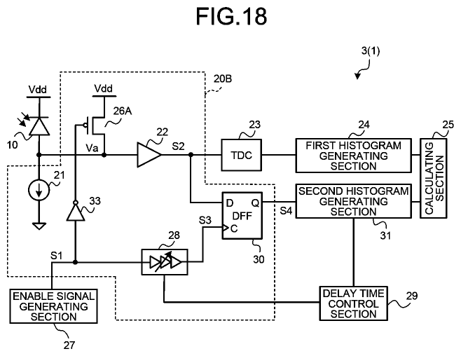

FIG. 18 is a block diagram depicting a configuration of a light receiving section 3 according to the fifth modification example of the embodiment of the present disclosure. As depicted in FIG. 18, in the light receiving section 3 according to the fifth modification example, a configuration of a unit circuit 20B is different from that of the embodiment.

Specifically, in the unit circuit 20B of the fifth modification example, an output section 22 is connected not to a cathode of an APD 10 but to an anode of the APD 10. That is, in the fifth modification example, instead of a cathode voltage Vc of the APD 10, an anode voltage Va of the APD 10 is supplied to the output section 22.

A point different between a configuration of the fifth modification example depicted in FIG. 18 and that of the embodiment depicted in FIG. 5 will be further described. The cathode of the APD 10 is connected to a power supply voltage Vdd, and the anode of the APD 10 is connected to an input terminal of a charging section 21 that is a constant current source. An output terminal of the charging section 21 that is the constant current source is grounded.

An element operating section 26A according to the fifth modification example includes a P-type transistor, a source of the P-type transistor is connected to the power supply voltage Vdd, and a drain of the P-type transistor is connected between the APD 10 and the output section 22. Furthermore, via an inverter 33, an enable signal S1 is supplied to a gate of the element operating section 26A that is the P-type transistor.

Then, in a case where the high-level enable signal S1 is supplied to the element operating section 26A via the inverter 33, a constant current from the charging section 21 flows to the element operating section 26A instead of the APD 10 since the element operating section 26A is in a conductive state. As a result, since the APD 10 is not charged, the APD 10 is brought into an invalid state.

On the other hand, in a case where the low-level enable signal S1 is supplied to the element operating section 26A via the inverter 33, the constant current from the charging section 21 is supplied to the APD 10 since the element operating section 26A is in a disconnected state. As a result, since the APD 10 is charged, the APD 10 is brought into a valid state.

As described above, similarly to the embodiment, the APD 10 can be switched between the valid state and the invalid state by switching of levels of the enable signal S1 in the fifth modification example.

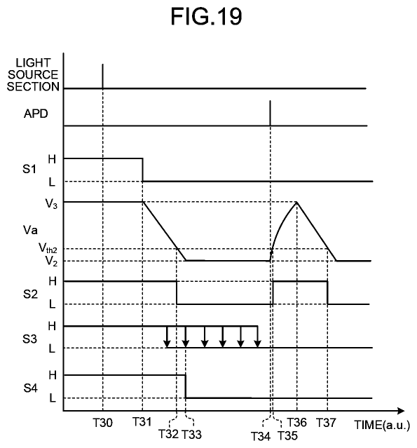

FIG. 19 is a description view depicting operation of a ranging system 1 according to the fifth modification example of the embodiment of the present disclosure in a timing chart, and is a view corresponding to FIG. 6 in the embodiment. As depicted in FIG. 19, in the ranging system 1 according to the fifth modification example, the enable signal S1 is set to the high level and the APD 10 is brought into the invalid state at time T30 that is a timing at which a light source section 2 emits light.

As a result, it is possible to prevent unintended reflected light reflected in a housing of the ranging system 1 or the like from becoming incident on the APD 10 and invalidating the APD 10.

An enable signal generating section 27 switches the enable signal S1 to the low level at time T31 that is after a predetermined time from the time T30 at which the light source section 2 emits the light. As a result, recharging of the APD 10 is started, and the anode voltage Va of the APD 10 is linearly stepped down from a predetermined voltage V₃.

Then, at time T32 at which the anode voltage Va of the APD 10 becomes lower than a threshold voltage Vₜₕ₂, the output section 22 outputs a low-level state signal S2. Furthermore, the anode voltage Va of the APD 10 is stepped down to a predetermined voltage V₂ by the charging section 21. In such a manner, the anode voltage Va is stepped down to the voltage V₂, and the APD 10 to which a predetermined reverse bias voltage is applied is brought into a Geiger mode.

In parallel with the charging processing of the APD 10 described above, a signal delay section 28 outputs a delay enable signal S3 in which a fall is delayed for a predetermined time from the time T31 at which the enable signal S1 is switched to the low level.

Here, as depicted in FIG. 19, the signal delay section 28 outputs a plurality of the delay enable signals S3 having different switching timings on the basis of a plurality of delay times set in such a manner that sweeping is performed within a predetermined time range.

Then, an APD state detecting section 30 outputs a low-level signal S4 at time T33 which is after the time T32, the state signal S2 being switched to the low level at the time T32, and at which a delay enable signal S3 having a switching timing closest to the time T32 is switched to the low level.

Then, in the fifth modification example, a second histogram generating section 31 generates a histogram of a raw count value based on the signal S4, differentiates the histogram of the raw count value, and generates a second histogram, similarly to the embodiment.

In the second histogram of the fifth modification example, time from the timing at which the enable signal S1 is switched (corresponding to time T31) to a timing at which the APD 10 is brought into the valid state (corresponding to time T33) is classified on the basis of time bins.

That is, in the fifth modification example, the time from the timing at which the enable signal S1 is switched to the timing at which the APD 10 is brought into the valid state can be measured by the signal delay section 28, the APD state detecting section 30, and the like, similarly to the embodiment.

Then, in the example of FIG. 19, it can be considered that no photon is incident on the APD 10 (APD 10 is quickly charged) until the anode voltage Va of the APD 10 reaches the threshold voltage Vₜₕ₂.

When a photon caused by reflected light from an object to be measured X is incident on the APD 10 at time T34 after the APD 10 becomes the Geiger mode, avalanche multiplication is generated inside the APD 10 due to an electron generated in response to the incidence of the photon. As a result, current flows through the APD 10, a voltage drop is generated, and the anode voltage Va nonlinearly rises.

Then, when the anode voltage Va becomes equal to or higher than the threshold voltage Vₜₕ₂ at time T35, the output section 22 outputs the high-level state signal S2.

Then, since the avalanche amplification in the APD 10 stops at time T36, the anode voltage Va of the APD 10 stops rising at the voltage V₃. Furthermore, the anode voltage Va of the APD 10 decreases as the APD 10 is recharged by the charging section 21.

Then, at time T37 at which the anode voltage Va of the APD 10 becomes lower than the threshold voltage Vₜₕ₂, the output section 22 outputs the low-level state signal S2. Furthermore, the anode voltage Va of the APD 10 is stepped down to the predetermined voltage V₂, and the APD 10 returns to the Geiger mode.

Here, in the fifth modification example, a TDC 23 measures time from a light emission timing at which the light source section 2 emits light (corresponding to time T30) to a light reception timing at which the APD 10 receives the light (corresponding to time T34). Note that in the fifth modification example, the time T35 at which the state signal S2 is switched to the high level is regarded as the timing at which the APD 10 receives the light.

Then, a first histogram generating section 24 generates a first histogram on the basis of the time from the light emission timing to the light reception timing which time is measured by the TDC 23. Then, in a case where a peak is detected in the first histogram, a calculating section 25 calculates the distance D to the object to be measured X on the basis of the above-described equation (1).

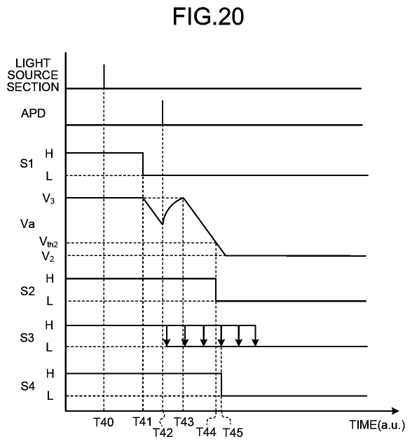

FIG. 20 is a description view illustrating the operation of the ranging system 1 according to the fifth modification example of the embodiment of the present disclosure in a timing chart, and illustrating a case where the object to be measured X is at a close position compared to the example of FIG. 19 described above.

As depicted in FIG. 20, similarly to the example of FIG. 19, in the ranging system 1 according to the fifth modification example, the enable signal S1 is set to the high level and the APD 10 is brought into the invalid state at time T40 that is a timing at which the light source section 2 emits light.

The enable signal generating section 27 switches the enable signal S1 to the low level at time T41 that is after a predetermined time from the time T40 at which the light source section 2 emits the light. As a result, charging of the APD 10 is started, and the anode voltage Va of the APD 10 is linearly stepped down from the predetermined voltage V₃.

However, in the example of FIG. 20, since the object to be measured X is at the close position, a photon caused by reflected light from the object to be measured X becomes incident on the APD 10 at time T42 before the anode voltage Va of the APD 10 becomes lower than the threshold voltage Vₜₕ₂.

Then, avalanche multiplication is generated inside the APD 10 due to an electron generated in response to the incidence of the photon, current flows through the APD 10, and a voltage drop is generated, whereby the anode voltage Va rises nonlinearly.

Then, since the avalanche amplification in the APD 10 stops at time T43, the anode voltage Va of the APD 10 stops rising at the voltage V₃. Furthermore, the anode voltage Va of the APD 10 decreases as the APD 10 is recharged by the charging section 21.

Then, at time T44 at which the anode voltage Va of the APD 10 becomes lower than the threshold voltage Vₜₕ₂, the output section 22 outputs the low-level state signal S2. Furthermore, the anode voltage Va of the APD 10 is stepped down to the predetermined voltage V₂, and the APD 10 is brought into the Geiger mode.

In parallel with the charging processing of the APD 10 described above, the signal delay section 28 outputs the delay enable signal S3 in which a fall is delayed for a predetermined time from the time T41 at which the enable signal S1 is switched to the low level.

Similarly to the example of FIG. 19, the signal delay section 28 outputs a plurality of the delay enable signals S3 having different switching timings on the basis of the plurality of delay times set in such a manner that sweeping is performed within the predetermined time range.

Then, the APD state detecting section 30 outputs the low-level signal S4 at time T45 which is after the time T44, the state signal S2 being switched to the low level at the time T44, and at which a delay enable signal S3 having a switching timing closest to the time T44 is switched to the low level.

Then, in the fifth modification example, the second histogram generating section 31 generates a histogram of a raw count value based on the signal S4, differentiates the histogram of the raw count value, and generates the second histogram. Then, the calculating section 25 calculates the distance D to the object to be measured X on the basis of a peak position of the second histogram.

As described above, similarly to the embodiment, in addition to the calculation processing of the distance D by the first histogram, the distance D can be calculated by utilization of the second histogram with respect to the object to be measured X at a short distance in the fifth modification example. Thus, according to the fifth modification example, a distance measuring range can be expanded in the direct ToF method.

### Effect

The ranging device (light receiving section 3) according to the embodiment includes the avalanche photodiode (APD) 10, the first histogram generating section 24, the element operating section 26, the second histogram generating section 31, and the calculating section 25. The first histogram generating section 24 generates the first histogram that is a histogram of the time from the timing at which the light source (light source section 2) emits light to the timing at which the APD 10 receives the light. The element operating section 26 enables the operation of the APD 10 on the basis of the enable signal S1. The second histogram generating section 31 generates the second histogram that is a histogram of the time from the timing at which the enable signal S1 is switched to the timing at which the APD 10 is brought into the valid state. The calculating section 25 calculates the distance D to the object to be measured X on the basis of at least one of the first histogram or the second histogram.

As a result, a distance measuring range can be expanded in the direct ToF method.

Furthermore, the ranging device (light receiving section 3) according to the embodiment further includes the output section 22 and the time-to-digital conversion circuit (TDC) 23. The output section 22 outputs the state signal S2 indicating a voltage state of the APD 10. The time-to-digital conversion circuit (TDC) 23 measures the time from the timing at which the light source (light source section 2) emits light to the timing at which the APD 10 receives the light on the basis of the state signal S2. The first histogram generating section 24 generates the first histogram on the basis of a measurement result of the time-to-digital conversion circuit (TDC) 23.

As a result, the distance D to the object to be measured X can be accurately calculated.

Furthermore, the ranging device (light receiving section 3) according to the embodiment further includes the signal delay section 28 and the APD state detecting section 30. The signal delay section 28 generates the delay enable signal S3 in which the enable signal S1 is delayed for a predetermined time. The APD state detecting section 30 includes the D-type flip-flop to which the state signal S2 and the delay enable signal S3 in which a delay time is swept are input. The second histogram generating section 31 differentiates a count value obtained by counting of the output from the APD state detecting section 30 for each time bin, and generates the second histogram.

As a result, it is possible to calculate the timing at which the reflected light from the object to be measured X at a close position is received, and to realize the ranging system 1 at low cost.

Furthermore, the ranging device (light receiving section 3) according to the embodiment includes the light receiving chip 200 in which the plurality of unit circuits 20 is two-dimensionally arrayed in a matrix, and the logic chip 210 which is stacked on the light receiving chip 200 and in which the plurality of unit circuits 20 is two-dimensionally arrayed in a matrix. Furthermore, each of the unit circuits 20 includes the element operating section 26, the signal delay section 28, and the APD state detecting section 30.

As a result, the distance D to the object to be measured X at the close position can be accurately calculated.

In addition, the ranging device (light receiving section 3) according to the embodiment includes the light receiving chip 200 in which the plurality of unit circuits 20A is two-dimensionally arrayed in a matrix, and the logic chip 210 which is stacked on the light receiving chip 200 and in which the plurality of unit circuits 20A is two-dimensionally arrayed in a matrix. Each of the unit circuits 20A includes the element operating section 26.

As a result, a chip area of the logic chip 210 can be reduced.

Furthermore, in the ranging device (light receiving section 3) according to the embodiment, the plurality of unit circuits 20A shares a set of the signal delay section 28 and the APD state detecting section 30 provided in the logic chip 210.

As a result, the ranging system 1 can be realized at low cost.

Furthermore, the ranging device (light receiving section 3) according to the embodiment includes the light receiving chip 200 in which the plurality of APDs 10 and the plurality of unit circuits 20A are two-dimensionally arrayed in a matrix, and the logic chip 210 stacked on the light receiving chip 200. In addition, each of the unit circuits 20A includes the element operating section 26, and the signal delay section 28 and the APD state detecting section 30 are provided in the logic chip 210.

As a result, the distance D to the object to be measured X at the close position can be accurately calculated.

Furthermore, in the ranging system 1 according to the embodiment, in a case where a peak is detected in the first histogram, the calculating section 25 calculates the distance D to the object to be measured X on the basis of the peak position of the first histogram. In addition, in a case where no peak is detected in the first histogram and a peak is detected in the second histogram, the calculating section 25 calculates the distance D to the object to be measured X on the basis of the peak position of the second histogram.

As a result, the power consumption of the ranging system 1 can be reduced.

Furthermore, in the ranging system 1 according to the embodiment, in a case where the peak position of the second histogram is equal to or larger than a predetermined threshold, the calculating section 25 calculates the distance D to the object to be measured X on the basis of the peak position of the second histogram.

As a result, the distance D to the object to be measured X at the close position can be accurately calculated.

### Application Example to a Mobile Body

A technology according to the present disclosure (present technology) can be applied to various products. For example, the technology according to the present disclosure may be realized as a device mounted on any of mobile bodies such as an automobile, an electric vehicle, a hybrid electric vehicle, a motorcycle, a bicycle, a personal mobility device, an airplane, a drone, a ship, and a robot.

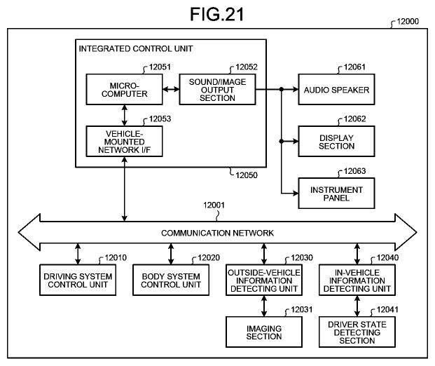

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

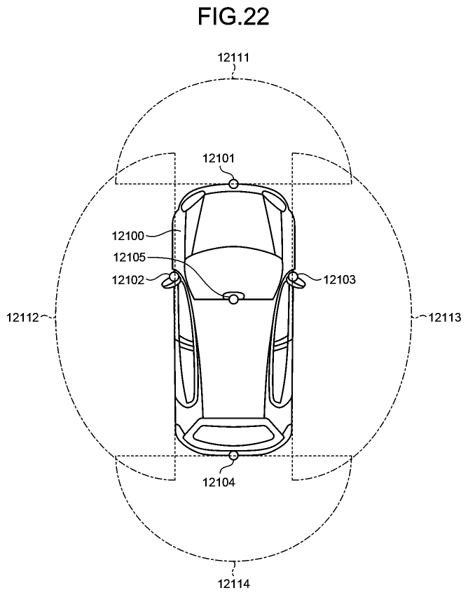

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, the ranging system 1 in FIG. 4 can be applied to the imaging section 12031. By applying the technology according to the present disclosure to the imaging section 12031, a distance measuring range of the imaging section 12031 can be expanded.

Although embodiments of the present disclosure have been described above, the technical scope of the present disclosure is not limited to the above-described embodiments as they are, and various modifications can be made within the spirit and scope of the present disclosure. Also, components of different embodiments and modification examples may be arbitrarily combined.

Furthermore, an effect described in the present description is merely an example and is not a limitation, and there may be a different effect.

Note that the present technology can also have the following configurations.

(1)

A ranging device comprising:

an avalanche photodiode (APD);

a first histogram generating section that generates a first histogram that is a histogram of time from a timing at which a light source emits light to a timing at which the APD receives the light;

an element operating section that enables operation of the APD on a basis of an enable signal;

a second histogram generating section that generates a second histogram that is a histogram of time from a timing at which the enable signal is switched to a timing at which the APD is brought into a valid state; and

a calculating section that calculates a distance to an object to be measured on a basis of at least one of the first histogram or the second histogram.

(2)

The ranging device according to the above (1), further comprising

an output section that outputs a state signal indicating a voltage state of the APD, and

a time-to-digital conversion circuit that measures the time from the timing at which the light source emits the light to the timing at which the APD receives the light on a basis of the state signal, wherein

the first histogram generating section generates the first histogram on a basis of a measurement result of the time-to-digital conversion circuit.

(3)

The ranging device according to the above (2), further comprising

a signal delay section that generates a delay enable signal in which the enable signal is delayed for a predetermined time, and

an APD state detecting section including a D-type flip-flop to which the state signal and the delay enable signal in which a delay time is swept are input, wherein

the second histogram generating section differentiates a count value obtained by counting of an output from the APD state detecting section for each time bin, and generates the second histogram.

(4)

The ranging device according to the above (3), further comprising

a light receiving chip in which a plurality of the APDs is two-dimensionally arrayed in a matrix, and

a logic chip which is stacked on the light receiving chip and in which a plurality of unit circuits is two-dimensionally arrayed in a matrix, wherein

each of the unit circuits includes the element operating section, the signal delay section, and the APD state detecting section.

(5)

The ranging device according to the above (3), further comprising

a light receiving chip in which a plurality of the APDs is two-dimensionally arrayed in a matrix, and

a logic chip which is stacked on the light receiving chip and in which a plurality of unit circuits is two-dimensionally arrayed in a matrix, wherein

each of the unit circuits includes the element operating section.

(6)

The ranging device according to the above (5), wherein

the plurality of unit circuits shares a set of the signal delay section and the APD state detecting section provided in the logic chip.

(7)

The ranging device according to the above (3), further comprising

a light receiving chip in which a plurality of the APDs and a plurality of unit circuits are respectively arrayed two-dimensionally in matrixes, and

a logic chip stacked on the light receiving chip, wherein

each of the unit circuits includes the element operating section, and

the signal delay section and the APD state detecting section are provided in the logic chip.

(8)

The ranging device according to any one of the above (1) to (7), wherein

the calculating section

calculates a distance to an object to be measured on a basis of a peak position of the first histogram in a case where a peak is detected in the first histogram, and

calculates the distance to the object to be measured on a basis of a peak position of the second histogram in a case where no peak is detected in the first histogram and a peak is detected in the second histogram.

(9)

The ranging device according to the above (8), wherein

the calculating section

calculates the distance to the object to be measured on a basis of the peak position of the second histogram in a case where the peak position of the second histogram is equal to or larger than a predetermined threshold.

A ranging system comprising:

a light source section that emits emission light; and

a light receiving section that receives reflected light of the emission light, wherein

the light receiving section includes

an avalanche photodiode (APD),

a first histogram generating section that generates a first histogram that is a histogram of time from a timing at which a light source emits light to a timing at which the APD receives the light,

an element operating section that enables operation of the APD on a basis of an enable signal,

a second histogram generating section that generates a second histogram that is a histogram of time from a timing at which the enable signal is switched to a timing at which the APD is brought into a valid state, and

a calculating section that calculates a distance to an object to be measured on a basis of at least one of the first histogram or the second histogram.

(11)

The ranging system according to the above (10), in which

the light receiving section further includes

an output section that outputs a state signal indicating a voltage state of the APD, and

a time-to-digital conversion circuit that measures time from a timing at which the light source emits light to a timing at which the APD receives the light on the basis of the state signal, and

the first histogram generating section generates the first histogram on the basis of a measurement result of the time-to-digital conversion circuit.

The ranging system according to the above (11), in which

the light receiving section further includes

a signal delay section that generates a delay enable signal in which the enable signal is delayed for a predetermined time, and

an APD state detecting section including a D-type flip-flop to which the state signal and the delay enable signal in which a delay time is swept are input, and

the second histogram generating section differentiates a count value obtained by counting of an output from the APD state detection section for each time bin, and generates the second histogram.

(13)

The ranging system according to the above (12), in which

the light receiving section includes

a light receiving chip in which a plurality of the APDs is two-dimensionally arrayed in a matrix, and

a logic chip which is stacked on the light receiving chip and in which a plurality of unit circuits is two-dimensionally arrayed in a matrix, and

each of the unit circuits includes the element operating section, the signal delay section, and the APD state detecting section.

(14)

The ranging system according to the above (12), in which

the light receiving section includes

a light receiving chip in which a plurality of the APDs is two-dimensionally arrayed in a matrix, and

a logic chip which is stacked on the light receiving chip and in which a plurality of unit circuits is two-dimensionally arrayed in a matrix, and

each of the unit circuits includes the element operating section.

(15)

The ranging system according to the above (14), in which

the plurality of unit circuits shares a set of the signal delay section and the APD state detecting section provided in the logic chip.

(16)

The ranging system according to the above (12), in which

the light receiving section includes

a light receiving chip in which a plurality of the APDs and a plurality of unit circuits are respectively arrayed two-dimensionally in matrixes, and

a logic chip stacked on the light receiving chip, and

each of the unit circuits includes the element operating section, and

the signal delay section and the APD state detecting section are provided in the logic chip.

(17)

The ranging system according to any one of the above (10) to (16), in which

the calculating section

calculates a distance to an object to be measured on the basis of a peak position of the first histogram in a case where a peak is detected in the first histogram, and

calculates the distance to the object to be measured on the basis of a peak position of the second histogram in a case where no peak is detected in the first histogram and a peak is detected in the second histogram.

(18)

The ranging system according to (17), in which

the calculating section

calculates the distance to the object to be measured on the basis of the peak position of the second histogram in a case where the peak position of the second histogram is equal to or larger than a predetermined threshold.

### REFERENCE SIGNS LIST

1 RANGING SYSTEM
2 LIGHT SOURCE SECTION (EXAMPLE OF LIGHT SOURCE)
3 LIGHT RECEIVING SECTION (EXAMPLE OF RANGING DEVICE)
10 APD
20, 20A, 20B UNIT CIRCUIT
22 OUTPUT SECTION
23 TIME-TO-DIGITAL CONVERSION CIRCUIT (TDC)
24 FIRST HISTOGRAM GENERATING SECTION
25 CALCULATING SECTION
26, 26A ELEMENT OPERATING SECTION
28 SIGNAL DELAY SECTION
30 APD STATE DETECTING SECTION
31 SECOND HISTOGRAM GENERATING SECTION
S1 ENABLE SIGNAL
S2 STATE SIGNAL
S3 DELAY ENABLE SIGNAL
200 LIGHT RECEIVING CHIP
210 LOGIC CHIP

1. A ranging device comprising:
an avalanche photodiode (APD);
a first histogram generating section that generates a first histogram that is a histogram of time from a timing at which a light source emits light to a timing at which the APD receives the light;
an element operating section that enables operation of the APD on a basis of an enable signal;
a second histogram generating section that generates a second histogram that is a histogram of time from a timing at which the enable signal is switched to a timing at which the APD is brought into a valid state; and
a calculating section that calculates a distance to an object to be measured on a basis of at least one of the first histogram or the second histogram.

2. The ranging device according to claim 1, further comprising
an output section that outputs a state signal indicating a voltage state of the APD, and
a time-to-digital conversion circuit that measures the time from the timing at which the light source emits the light to the timing at which the APD receives the light on a basis of the state signal, wherein
the first histogram generating section generates the first histogram on a basis of a measurement result of the time-to-digital conversion circuit.

3. The ranging device according to claim 2, further comprising
a signal delay section that generates a delay enable signal in which the enable signal is delayed for a predetermined time, and
an APD state detecting section including a D-type flip-flop to which the state signal and the delay enable signal in which a delay time is swept are input, wherein
the second histogram generating section differentiates a count value obtained by counting of an output from the APD state detecting section for each time bin, and generates the second histogram.

4. The ranging device according to claim 3, further comprising
a light receiving chip in which a plurality of the APDs is two-dimensionally arrayed in a matrix, and
a logic chip which is stacked on the light receiving chip and in which a plurality of unit circuits is two-dimensionally arrayed in a matrix, wherein
each of the unit circuits includes the element operating section, the signal delay section, and the APD state detecting section.

5. The ranging device according to claim 3, further comprising
a light receiving chip in which a plurality of the APDs is two-dimensionally arrayed in a matrix, and
a logic chip which is stacked on the light receiving chip and in which a plurality of unit circuits is two-dimensionally arrayed in a matrix, wherein
each of the unit circuits includes the element operating section.

6. The ranging device according to claim 5, wherein
the plurality of unit circuits shares a set of the signal delay section and the APD state detecting section provided in the logic chip.

7. The ranging device according to claim 3, further comprising
a light receiving chip in which a plurality of the APDs and a plurality of unit circuits are respectively arrayed two-dimensionally in matrixes, and
a logic chip stacked on the light receiving chip, wherein
each of the unit circuits includes the element operating section, and
the signal delay section and the APD state detecting section are provided in the logic chip.

8. The ranging device according to claim 1, wherein
the calculating section
calculates a distance to an object to be measured on a basis of a peak position of the first histogram in a case where a peak is detected in the first histogram, and
calculates the distance to the object to be measured on a basis of a peak position of the second histogram in a case where no peak is detected in the first histogram and a peak is detected in the second histogram.

9. The ranging device according to claim 8, wherein
the calculating section
calculates the distance to the object to be measured on a basis of the peak position of the second histogram in a case where the peak position of the second histogram is equal to or larger than a predetermined threshold.

10. A ranging system comprising:
a light source section that emits emission light; and
a light receiving section that receives reflected light of the emission light, wherein
the light receiving section includes
an avalanche photodiode (APD),
a first histogram generating section that generates a first histogram that is a histogram of time from a timing at which a light source emits light to a timing at which the APD receives the light,
an element operating section that enables operation of the APD on a basis of an enable signal,
a second histogram generating section that generates a second histogram that is a histogram of time from a timing at which the enable signal is switched to a timing at which the APD is brought into a valid state, and
a calculating section that calculates a distance to an object to be measured on a basis of at least one of the first histogram or the second histogram.
